(19) United States
(12) Patent Application Publication
(10) Pub. No.: US 2004/0199372 A1
(43) Pub. Date: Oct. 7, 2004

(54) System, method, and computer program product for configuring stochastic simulation models in an object oriented environment

(76) Inventor: Derek Charles Penn, San Francisco, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/833,250

(22) Filed: Apr. 28, 2004

Related U.S. Application Data
(63) Continuation of application No. 09/547,793, filed on Apr. 12, 2000.
(60) Provisional application No. 60/148,745, filed on Aug. 13, 1999.

(51) Int. Cl. G06F 9/45

(52) U.S. Cl. 703/22

(57) ABSTRACT

A system, method, and computer program product for configuring a stochastic simulation model. According to the method of the present invention, an arbitrarily complex functional expression is created from a library of functional expression components. A proxy/adapter object is also created. The proxy/adapter object serves as an intermediary between the arbitrarily complex functional expression and a target domain object within the stochastic simulation model so as to modify a property of the target domain object in accordance with the arbitrarily complex functional expression at runtime.

This application claims the benefit under 35 U.S.C. §119(e) of U.S. Provisional Application No. 60/198,745, filed Aug. 13, 1999, which is incorporated by reference herein in its entirety.

### CROSS-REFERENCE TO RELATED APPLICATIONS

This patent application is potentially related to the following co-pending U.S. utility patent applications:

“A System, Method, and Computer Program Product for Handling Deferred Expressions in an Object Oriented Stochastic Simulation Model, ” Serial No. (to be assigned), Attorney Docket No. 1881.0130000, by Derek Penn, filed concurrently herewith and incorporated in its entirety herein by reference.

### BACKGROUND OF THE INVENTION

1. Field of the Invention

The present invention relates generally to the field of software-based simulations, and more particularly, to software-based simulations involving stochastic variables and multi-period states. The invention further relates to an object-oriented software architecture for building and processing stochastic models.

2. Related Art

Software-based simulation programs have wide applicability to a large number of problems ranging from the modeling of physical processes for the purpose of scientific experimentation to economic models designed for the purpose of forecasting future macro- or micro-economic states. One type of software-based simulation is a stochastic simulation. Stochastic simulations calculate the behavior of some entity or set of entities over a number of discrete periods (referred to as multi-period), where one or more of the entity's underlying properties or attributes may vary in an uncertain or probabilistic manner. In multi-period, stochastic simulations, an entity's property or attribute usually varies in a stochastic manner over the discrete, non-continuous periods of a given simulation run.

Stochastic simulations find great utility in such fields as social science, business management, interactive games, and financial planning. These fields typically address problems that involve a large number of stochastic variables that require the performance of complex calculations during each period of a simulation run. The interaction between various entities within the model may also be quite complex, requiring numerous entity dependencies and functional relationships. The ability of object oriented (OO) software languages to support data encapsulation and inheritance make them particularly well-suited for stochastic simulations that require numerous entity dependencies and functional relationships.

Conventional object oriented stochastic simulation programs are typically inflexible. The programs are usually designed for a single, specific problem. The structure of the underlying simulation model is determined in advance and the type and behavior of the entity's properties or attributes are “hard-coded” into the program architecture. Properties which are stochastic are predefined by the software architecture and cannot be changed by the end-user. While the end-user may change the value of some input variables, the end-user cannot alter the underlying structure of the model or determine, at runtime, which properties will be stochastic and which probability distributions will be used to model the stochastic nature of the property.

Another problem with the existing object oriented stochastic simulation programs is that the number and type of outputs have also been predefined. Typically, the simulation software is intimately tied to a specific user-interface which predetermines what outputs can be viewed by the end-user and in form they will be presented to the end-user.

Yet another problem with the existing architecture of object oriented stochastic simulations is that they provide no separation between the properties of an entity and the simulation engine. The simulation engine is the structure that enables the object oriented programs to execute. The object structures and simulation engine classes are often inter-dependent and cannot be easily changed by the end-user. Also, the number and behavior of different entity classes is predefined by the simulation engine, and is difficult, if not impossible, to add to or change the behavior of the entities without modifying the entire framework.

In the past, many simulation applications were designed to run on desktop computers in which the simulation was limited by the computing power of the desktop computers. The applications that were designed for object oriented stochastic simulations usually modeled one thing and were programmed with predefined variables that could not be modified at runtime.

What is needed is a flexible system and method for providing a discrete event simulation space to enable the execution of performance intensive, object oriented stochastic simulations. What is also needed is a system and method for an object oriented stochastic simulation that allows an end-user to define and modify inputs as well as outputs to the stochastic simulation at runtime. What is further needed is a system and method for an object-oriented stochastic simulation that allows an end-user to add to or change the behavior of an entity without having to modify the simulation engine.

### SUMMARY OF THE INVENTION

The present invention solves the above-mentioned problems by providing a system, method, and computer program product for configuring a stochastic simulation model. According to the method of the present invention, an arbitrarily complex functional expression is created from a library of functional expression components. A proxy/adapter object is also created. The proxy/adapter object serves as an intermediary between the arbitrarily complex functional expression and a target object within the stochastic simulation model so as to modify a property of the target object in accordance with the arbitrarily complex functional expression.

The present invention provides an object oriented software architecture for performing multi-period simulations in a manner that allows the stochastic attributes of a model's properties to be determined at runtime. Unlike existing architectures, the present invention allows practically any property of any domain entity to be the subject of a user-defined probability distribution. The set of properties that are stochastic may be determined by a host application or end-user. The modeling of a given property's stochastic behavior can also be determined at runtime.

The present invention also allows a set of output properties to be determined at runtime by the end-user. Only those properties designated as output properties by the end-user will be tracked by the simulation. This feature makes program execution more efficient.

The present invention does not require any special code on the part of an individual object class. In other words, the code for each domain object contained in its class description does not need to know or have any interaction with the mechanisms used to generate stochastic input properties or monitor the set of output properties. The invention allows for object classes which were created independently from and without prior knowledge of the invention to be included in a simulation model processed by the invention.

The present invention can be used with a variety of different kinds of host applications and can be adapted to a variety of user-interfaces.

Further features and advantages of the invention, as well as the structure and operation of various embodiments of the invention, are described in detail below with reference to the accompanying drawings.

### BRIEF DESCRIPTION OF THE FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 is a block diagram illustrating the manner in which a proxy/adapter is used to modify properties of an object in an object-oriented stochastic simulation space according to an embodiment of the present invention.

FIG. 2A is a flow diagram illustrating a method for modifying an object's input properties using a proxy/adapter.

FIG. 2B is a flow diagram illustrating-a method for modifying an object's output properties using a proxy/adapter.

FIG. 3 illustrates exemplary functional expression components that may be found in a library of functional expression components according to an embodiment of the present invention.

FIG. 4 is a flow diagram illustrating a simulation framework/engine for implementing an embodiment of the present invention.

FIG. 5 is a flow diagram illustrating an initialization process of a simulation framework/engine according to an embodiment of the present invention.

FIG. 6 is a flow diagram illustrating a processing method of a simulation framework/engine according to an embodiment of the present invention.

FIG. 7 illustrates an exemplary output matrix for an output value of a simulation experiment according to an embodiment of the present invention.

FIG. 8 is a diagram illustrating an exemplary computer system.

The features, objects, and advantages of the present invention will become more apparent from the detailed description set forth below when taken in conjunction with the drawings in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION OF THE PREFERRED EMBODIMENTS

### TABLE OF CONTENTS

I. An Overview of the Invention

A. Terminology

B. The Invention

II. A Proxy/Adapter in an Object Oriented Stochastic Simulation Space

III. Functional Expression Components

IV. A Stochastic Simulation Framework/Engine

A. The Initialization Phase

B. The Processing Phase

C. The Output Phase

1. Output Data for Analysis and Display

2. Time Step Settings

3. Derived Output Data

V. Environment

VI. Conclusion

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the present invention would be of significant utility.

### I. An Overview of the Invention

### A. Terminology

To more clearly delineate the present invention, an effort is made throughout the specification to adhere to the following term definitions consistently.

The term “simulation” refers to both the general field and practice and to a given simulation experiment.

The term “domain” or “domain model” refers to a user-defined representation of a given problem or situation. Each domain model contains one or more domain objects that represent the various entities of the problem to be modeled.

The term “domain object” refers to a given entity in a domain model. Domain objects typically have one or more properties whose values may be monitored during the simulation to produce simulation output data.

The term “simulation experiment” refers to one or more models of a given domain whose behavior is to be simulated. Each “domain model” is made up of a set of independent domain “entities” that contain the internal logic and behavior specific to that entity. Each model is simulated over a “time horizon” or over “time”, where “time horizon” refers to a set of one or more discrete periods or steps. The “time horizon” may represent years, months, weeks, days, hours, minutes, seconds, etc. Simulation experiments are processed through all periods and all runs.

The term “run” refers to each iteration of the simulation over the time horizon. Each simulation experiment is evaluated over one or more runs, wherein the number of runs is usually quite large (i.e., >1000) in order to produce statistically reliable results. Each run is made up of the same number of discrete periods.

The term “period” refers to the interval of time between each update of the simulation model in a given run.

The term “output property” refers to a domain object property whose values are to be monitored and collected during the processing of the simulation.

The term “simulation output” refers to a set of data collected from all output properties from a given simulation experiment.

### B. The Invention

The present invention is a system and method for configuring an object oriented stochastic simulation. In an embodiment of the present invention, Java, developed by Sun Microsystems, Inc., is used as the object oriented programming language. Other object oriented programming languages that provide dynamic binding of method calls may also be used.

The present invention uses a proxy/adapter as an intermediary between a library of functional expression components and a target object to modify a property of the object. The target object's property is modified according to an arbitrarily complex functional expression that is generated using components within the library of functional expression components. The arbitrarily complex functional expression may include stochastic functions and inter-object relationship functions. Such functions are not deterministic. Stochastic functions and inter-object relationship functions only have a value at run-time.

Through the use of the proxy/adapter, the present invention allows an end-user to define inputs as well as outputs at run-time. An end-user may also specify derived output expressions. Derived output expressions create new output data that is derived from an original simulation output.

A simulation framework/engine repeatedly evaluates the behavior of the domain entities over a period of time. The simulation framework/engine is comprised of an initialization phase, a processing phase, and an output phase.

In the present invention, domain entities can refer to and depend on each other in a manner that is independent of the location of the objects. This is referred to as inter-object relationships or inter-object relationship functions. The initialization phase of the simulation framework/engine handles all inter-object relationships and stochastic functions in a single, consistent manner by generating a dependency graph of domain entities to each other.

The processing phase of the simulation framework/engine is responsible for processing a simulation model and updating each object for each period in a run. During the processing phase of the simulation, functional expressions are evaluated in the order in which they appear on the dependency graph.

The output phase of the simulation framework/engine provides a means for tracking the value of properties which have been designated as output properties, and for storing the output property values over the designated periods of the simulation.

### II. A Proxy/Adapter in an Object Oriented Stochastic Simulation Space

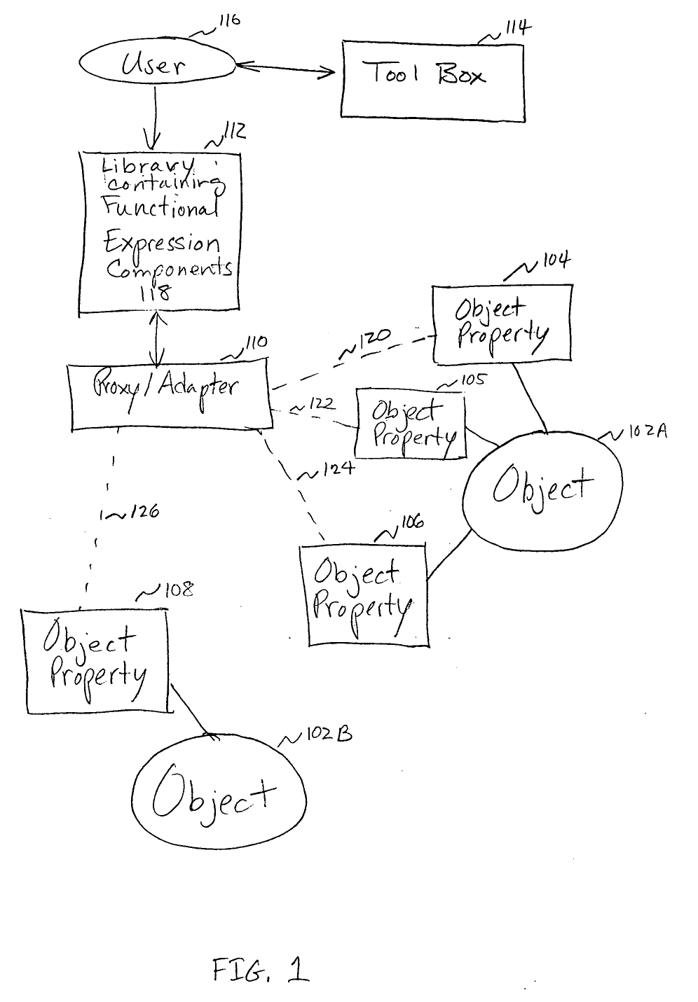

FIG. 1 is a block diagram-illustrating the manner in which a proxy/adapter is used to modify properties of an object in an object-oriented stochastic simulation space. As shown in FIG. 1, the invention provides a tool box 114 that a user 116 uses to generate new functional expression components 118 (functional expression components are described below). User 116 generates the new functional expression components in a well known manner to those skilled in the relevant art(s). In one embodiment, an administrator (not shown), as well as user 116, may interact with tool box 114 to generate new functional expression components.

The invention also provides a proxy/adapter 110 coupled to a library 112. Library 112 is used to store functional expression components 118 generated by user 116. Proxy/adapter 110 may connect to any one or all of a plurality of object properties to modify the properties of an object. Shown in phantom in FIG. 1, proxy/adapter 110 may connect to a plurality of object properties 104-106 from a first object 102A via connections 120, 122, and 124, and to an object property 108 from a second object 102B via a connection 126. Proxy/adapter 110 is used to modify object properties 104-106 and 108 as input properties to be entered into the simulation and/or as output properties to be tracked during execution of a simulation experiment. An object property may be designated as an input property, an output property, or an input property and an output property.

A proxy and an adapter are design patterns that are well known to those skilled in the relevant art(s). Adapter objects are commonly used to convert a given interface into another given interface by translating one interface into another. Proxy objects are most commonly used to allow communication between a remote object and a local object, wherein the local object communicates with the proxy by sending messages to the it. The proxy, in turn, passes the message on to the remote object, without being concerned as to the location of the remote object. Adapters and proxies are also used to insert figures, tables, and/or spreadsheets into text documents or vice versa.

The present invention combines the design patterns of the proxy and adapter objects to generate proxy/adapter object 110 for use in a stochastic simulation space. In one embodiment, a single proxy/adapter is used to specify all input properties and output properties for a simulation experiment. In another embodiment, a plurality of proxy/adapters are used to specify the input properties and output properties for a simulation experiment. For example, a different proxy/adapter may be used for each input and each output property requiring modification, or one proxy/adapter may be used for input properties and another proxy/adapter may be used for output properties, or a proxy/adapter for each type of input or output property may be used, such as a proxy/adapter for stochastic input and output functions, a proxy/adapter for deterministic input and output functions, and a proxy/adapter for inter-object relationship input and output functions. One skilled in the relevant art(s) would know that alternative methods of allocating proxy/adapters for input and output functions may be implemented without departing from the scope of the present invention.

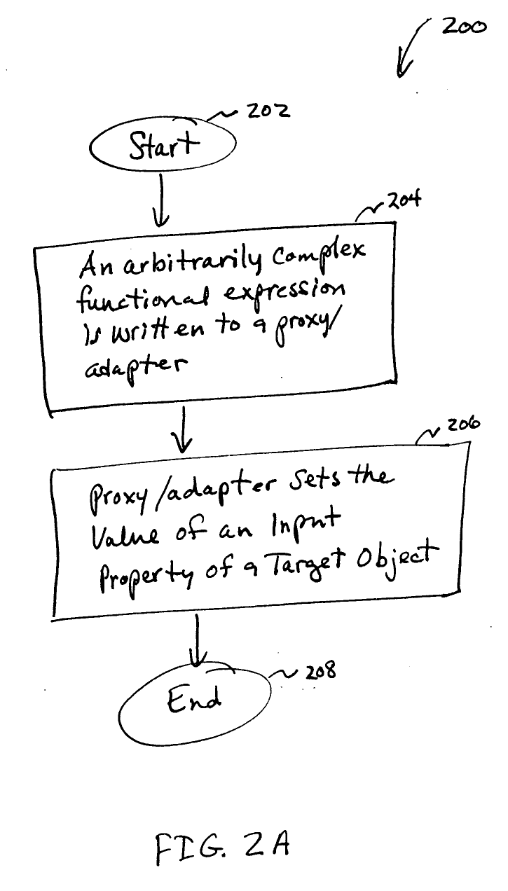

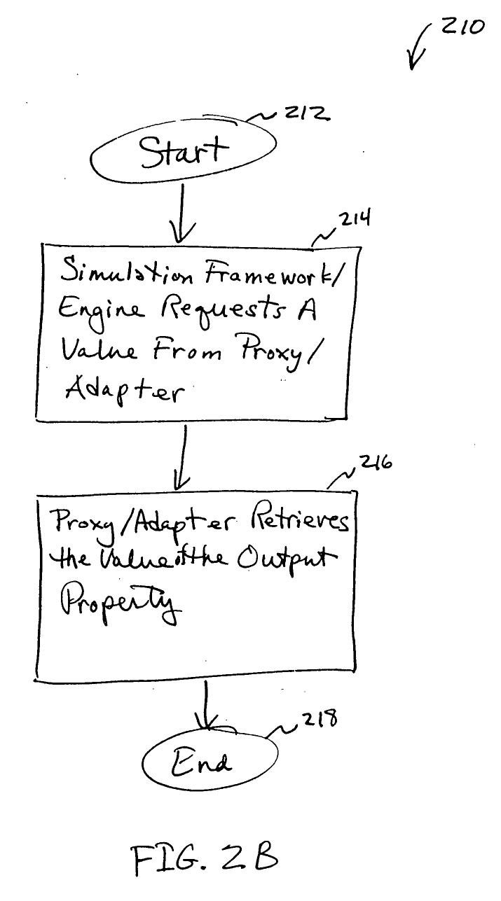

Proxy/adapter 110 acts as a transparent intermediary between library 112 and target objects within the stochastic simulation model so as to modify properties of the target objects in accordance with an arbitrarily complex functional expression. The arbitrarily complex functional expression is an arithmetic expression formed from one or more functional expression components found in library 112. In other words, proxy/adapter 110 modifies properties 104-108 of objects 102A and 102B, respectively, with arithmetic expressions formed from one or more functional expression components found in library 112. The operation of proxy/adapter 110 will be described in greater detail with reference to FIGS. 2A and 2B.

From an input property's point of view, proxy adapter 110 operates similar to an adapter design pattern. FIG. 2A is a flow diagram of a method for modifying an input property using proxy/adapter 110. The process begins with step 202, where control immediately passes to step 204.

In step 204, an arbitrarily complex functional expression is written to proxy/adapter 110 without knowing which input property will receive the expression. Control then passes to step 206.

In step 206, proxy adapter 110 sets the value of the property of the target object (102A or 102B, for example) to the arbitrarily complex functional expression. Control then passes to step 208, where the process ends.

From an output property's viewpoint, proxy adapter 110 operates similar to a proxy design pattern. FIG. 2B is a flow diagram of a method for retrieving the value of an output property using proxy/adapter 110. The process begins with step 212, where control immediately passes to step 214.

In step 214, the simulation framework/engine requests a value from proxy/adapter 110. Control then passes to step 216.

In step 216, proxy/adapter 110 retrieves the value of the output property without the simulation framework/engine knowing how the value was retrieved or from where it was retrieved. Control then passes to step 218, where the process ends.

### III. Functional Expression Components

The present invention allows the properties of objects in the simulation to be determined by the evaluation of arbitrarily complex functional expressions that are setup by the end-user at runtime. In one embodiment, the end-user may employ a scripting language to implement the arbitrarily complex functional expressions. Scripting languages are well known to those skilled in the relevant art(s). In another embodiment, the end-user may implement a graphical user interface (GUI) to implement the arbitrarily complex functional expressions. GUIs are also well known to those skilled in the relevant art(s).

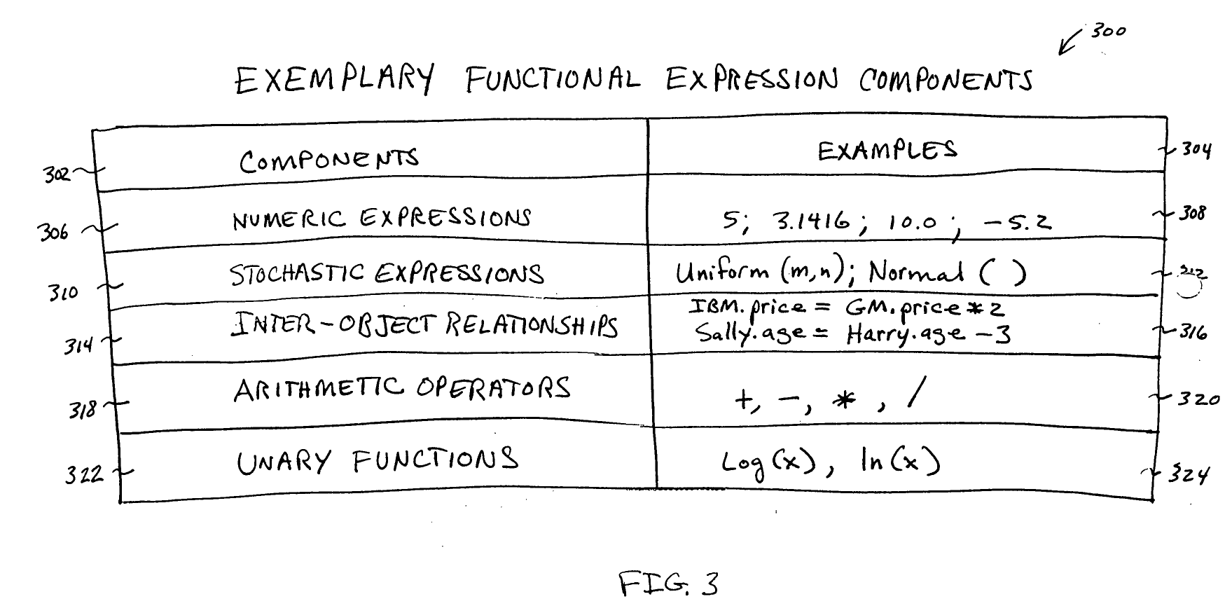

FIG. 3 illustrates the types of functional expression components that may be found in library 112. FIG. 3 contains a list of components 302 and a corresponding list of examples 304. Components list 302 includes numeric expressions 306, stochastic expressions 310, inter-object relationships 314, arithmetic operators 318, and unary expressions 322. Components list 302 is just a sample of the many types of expressions and operators that may be used to generate arbitrarily complex functional expressions. One skilled in the relevant art(s) would know that other types of expressions and operators may be used without departing from the scope of the present invention.

Numeric expressions 306 are numeric values. Examples list 304 shows examples of numeric expressions 308. The examples include, but are not limited to, 5, 3.1416, 10.0, and −5.2.

Stochastic expressions 310 are modeled using probability distributions. Stochastic expressions return random variates drawn from a specific probability distribution. Each time the given stochastic expression is evaluated, a new random variate is returned. Successive results from these expressions are independent and identically distributed. Examples list 304 provides examples of stochastic expressions 312. The examples include, but are not limited to, a uniform distribution and a normal distribution.

Inter-object relationships 314 are object properties that reference other object properties. Examples list 304 provides examples of inter-object relationships 316. In one example, the price of IBM stock references the price of General Motors stock. That is, IBM stock is twice the amount of General Motors stock. In another example, Sally's age references Harry's age. That is, Sally's age is Harry's age minus 3. With inter-object relationships, the present invention must insure that the referenced object is evaluated prior to the inter-object relationships expression being evaluated. Thus, the result of the expression cannot be evaluated immediately. Instead, the expression must be evaluated at runtime.

Arithmetic operators 318 take numeric values as their operands and return a single numeric value. Examples list 304 provides examples of arithmetic operators 320. Standard arithmetic operators 318 include addition, subtraction, multiplication, and division.

Unary expressions 322 take numeric values as their operand and return a single numeric value. Examples list 304 provides examples of unary expression 324. The examples include, but are not limited to, log(x) and ln(x).

End-users, via a GUI or a host application, may combine one or more functional expression components to form composite or nested functions, referred to as arbitrarily complex functional expressions, for defining input and/or output properties of domain objects. For example, stochastic expressions may be nested within other functional expression components to modify an input and/or output property. Returning to example 316 of an inter-object relationship 314, if Harry's age is defined as a uniform random variate between 20 and 30 (i.e., Uniform(20,30)), then Sally's age represents a composite function that includes an inter-object relationship (because it is dependent upon Harry's age), a stochastic expression (because Harry's age is a uniform random variate between 20 and 30), an arithmetic operator (−), and a numeric expression (3). No special code from the domain object is required. These arbitrarily complex functional expressions are evaluated at runtime using the stochastic simulation framework/engine.

### IV. A Stochastic Simulation Framework/Engine

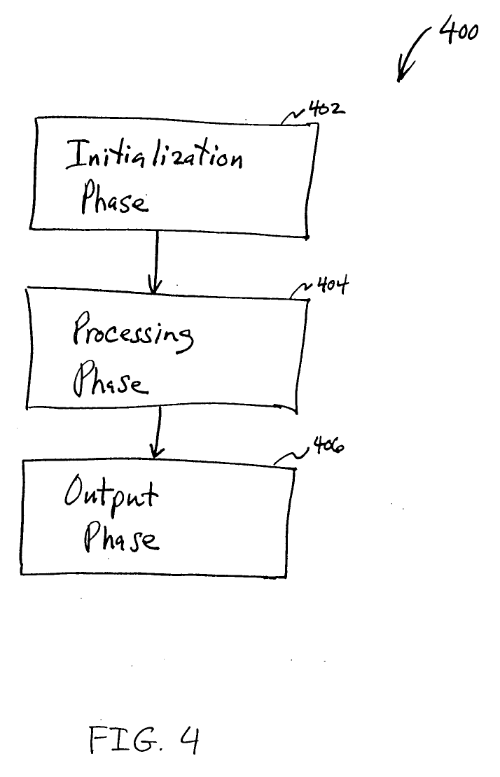

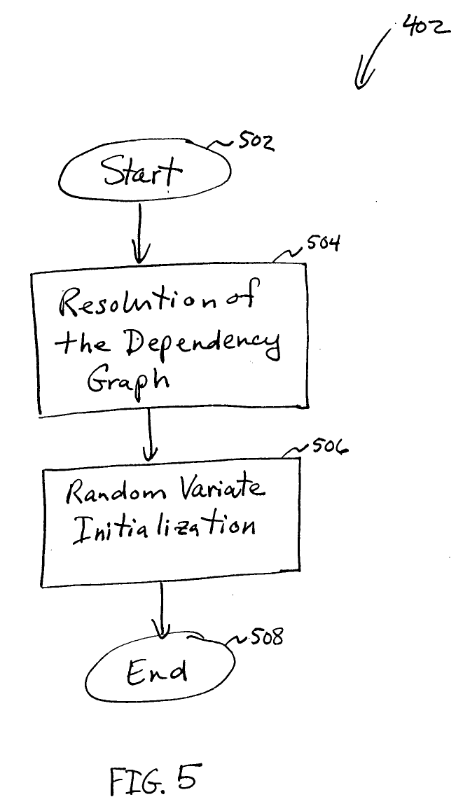

A stochastic simulation framework/engine processes the simulation model and controls the behavior of the input and output properties. The stochastic simulation framework/engine is responsible for making the various components of the present invention work together to process a particular simulation experiment by repeatedly evaluating the behavior of the domain entities over a period of time. FIG. 4 is a flow diagram illustrating a stochastic simulation framework/engine 400 for implementing an embodiment of the present invention. The stochastic simulation framework/engine 400 is comprised of an initialization phase 402, a processing phase 404, and an output phase 406. Each phase 402-406 of stochastic simulation framework/engine 400 is described in detail with reference to FIGS. 5, 6, and 7, respectively.

### A. The Initialization Phase

Initialization phase 402 of stochastic simulation framework/engine 400 handles all inter-object relationships and stochastic functions in a single, consistent manner. Initialization phase 402 also handles random variate correlations of object properties.

FIG. 5 is a flow diagram illustrating initialization phase 402 of stochastic simulation framework/engine 400. The process begins with step 502, where control immediately passes to step 504.

In the present invention, domain entities can refer to and depend on each other in a way that is independent of where the actual target object is located. In fact, a given domain model may have a plurality of objects, each with multiple dependencies on other domain objects in the model. In order to evaluate a domain entity (referred to as domain entity number 1) that references another domain entity (referred to as domain entity number 2), domain entity number 2 must be evaluated first. Referring back to example 316 in FIG. 3, where Sally's age is Harry's age-3, Harry's age must be evaluated first before Sally's age can be evaluated. Thus, prior to evaluating all of the arbitrarily complex functional expressions within a simulation experiment, the order in which they must be evaluated has to be determined. The present invention automatically determines the order in which each domain entity should be evaluated within the simulation.

Referring back to FIG. 5, the present invention automatically generates a dependency graph of domain entities and their relationships to other domain entities having stochastic expressions and inter-object relationship expressions. In step 504, a dependency graph of domain entities is generated. The dependency graph lists all domain entities in the order in which they must be evaluated during processing phase 404.

For example, assuming that Harry's age is equal to a random uniform variate between 20 and 30, and Sally's age is Harry's age minus 3, Harry's age is calculated first and then Sally's age is calculated. The dependency graph will be:

TABLE 1

| Domain Entity | Dependency | Functional Expression |
|---|---|---|
| Harry's age | — | Uniform (20, 30) |
| Sally's age | Harry's age | Harry's age − 3 |

Once the dependency graph is generated, control then passes to step 506.

The present invention also allows objects to be correlated with other objects. For example, stock A's price is equal to a uniform variate between 0 and 100 (Uniform (1,100)) and stock B's price is also equal to a uniform variate between 0 and 100. The end-user wants a positive correlation of 75% between the two stocks A and B. Thus, stocks A and B must move higher or lower together. The present invention also provides variance reduction techniques. Correlation and variance reduction techniques are well known to persons skilled in the relevant art(s).

In step 506, random variate initializations are performed to take into account correlations between domain objects and variance reduction techniques. Control then passes to step 508, where the process ends.

### B. The Processing Phase

The processing phase of simulation framework/engine 400 is responsible for processing a simulation model and updating each object for each period in a run. During the processing phase of the simulation, functional expressions are evaluated in the order in which they appear in the dependency graph. As previously stated, a simulation experiment is processed through all periods and all runs over a designated time horizon.

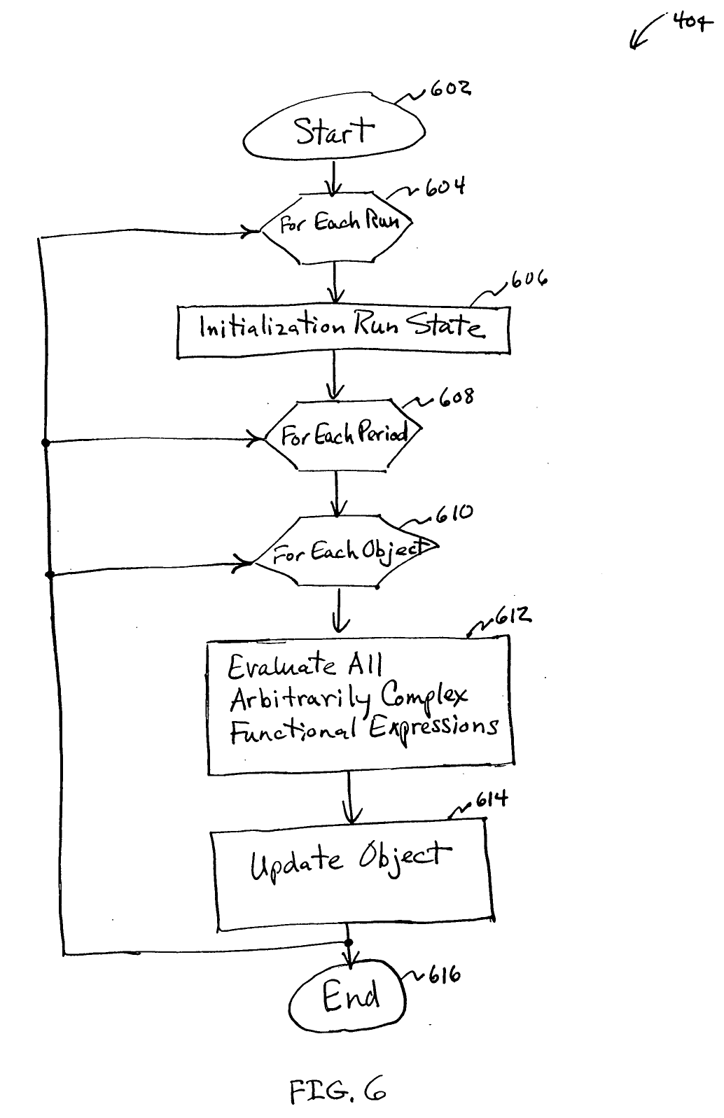

FIG. 6 is a flow diagram illustrating a processing method for stochastic simulation framework/engine 400. The process begins with step 602, where control is immediately passed to step 604.

In step 604, processing begins for each run. Control then passes to step 606.

In step 606, prior to actually processing a run in the simulation experiment, the simulation is initialized for a new run. Each object initializes itself to its original starting state. Control then passes to step 608.

In step 608, processing begins for each period. Control then passes to step 610.

In step 610, processing begins for each object. Control then passes to step 612.

In step 612, each arbitrarily complex functional expression is evaluated. Each expression is evaluated in the order in which it falls within the dependency graph. Control then passes to step 614.

In step 614, each object is updated at each period of every run. Each object updates its internal state accordingly before the next period is executed. Control then passes back to step 610 for repeating steps 612-614 until every object has been evaluated. Control then passes back to step 608 for repeating steps 610-614 until every period has been evaluated. Control then passes back to step 604 for repeating steps 606-614 until every run has been evaluated. Control then passes to step 616, where the process ends.

### C. The Output Phase

The output phase of simulation framework/engine 400 provides a means for tracking the value of properties which have been designated as output properties, and for storing the output property values over the designated periods of the simulation. At the termination of the experiment, the output components generate a set of data structures that may be used to display and analyze the data produced by the experiment.

1. Output Data for Analysis and Display

One embodiment of the present invention uses a matrix data structure to display output values. The matrix of output values has as many columns as periods in the current simulation experiment and as many rows as runs. At the termination of the experiment, the value of the property at any given period and run can therefore be retrieved from this matrix for analysis or display. One skilled in the relevant art(s) would know that other multidimensional output structures could be used without departing from the scope of the present invention.

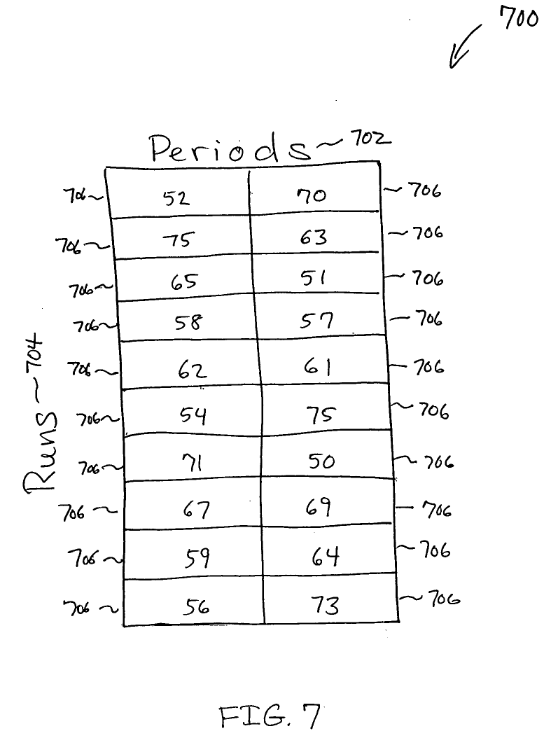

FIG. 7 illustrates an exemplary output matrix 700 for an output value of a simulation experiment. The output value is Harry's age at retirement. Harry's age at retirement is a random uniform variate between 50 and 75. The simulation is executed over a time horizon of 2 periods, each period having 10 runs. Output matrix 700 is therefore comprised of two periods 702 displayed in columns 1 and 2 and 10 runs 704 displayed in rows 1 through 10. Each entry 706 in matrix 700 represents Harry's age at retirement for period 702, run 704.

In one embodiment of the invention, sparse matrices are used to only allocate memory on an as needed basis. For example, if only the last period's value of a domain entity is to be monitored, memory is only allocated for storing the values for the last period. In another embodiment, all property outputs are stored in a single repository.

In one embodiment of the invention, a simulation output contains a one scenario instance for each domain model in the simulation. Each scenario instance contains one property output instance for each domain property whose values were monitored during the simulation experiment. Each property output instance contains the matrix of values generated during the simulation experiment as described in FIG. 7.

In an embodiment of the present invention, the output data is structured in such a way that it can be accessed as an n-dimensional space that can be manipulated from any perspective desired. For example, in a 4-dimensional space, each dimension corresponds to the following axes:

1. the domain model;

2. the property;

3. the period index; and

4. the run index.

Any specific value can be uniquely identified by specifying all four axes. Any given vector of values can be identified by specifying any three axes. Any matrix of values can be identified by specifying any two axes. For example, to retrieve the vector of values of a given property for a given period for all runs, an end-user would specify a scenario, property, and period. To retrieve the matrix of values of all properties for a given run, an end-user would specify a scenario and run.

2. Time Step Settings

The present invention allows an end-user to define a specific subset of periods in a given simulation. For example, it may be useful to specify that a certain property function should only be evaluated every other period or only in the first period, etc. The present invention provides a special utility object called a TimeStepSet, to define a set of periods in a given simulation. These objects can be used as filters to determine the periods at which a given domain object or function should be updated or executed. One set of TimeStepSet Objects is listed in Table 2. Other TimeStepSet Objects that determine the periods at which a given domain object or function should be updated or executed may be added without departing from the scope of the invention.

TABLE 2

| TimeStepSet Object | Definition |
|---|---|
| first ( ) | the first period of each run |
| last ( ) | the last period of each run |
| all ( ) | all periods of each run |
| firstandlast ( ) | first and last period of each run |
| interval (n) | every n periods |
| periods (a) | only the specified periods |
| periods (a, b, c) | |
| periods ([al . . . an]) | |
| range (m, n) | all periods between the mth and the |
| | nth period, inclusively |
| never ( ) | no periods |
| afterfirst ( ) | every period except the 0^{th} period in |
| | each run |

3. Derived Output Data

The present invention provides the ability to create new output data derived from the original simulation output. This derived output can be treated transparently by outside consumers and is indistinguishable from the original simulation output.

The derived output is not calculated during the actual execution of the simulation experiment. Thus, the calculation of derived output data does not impair the performance of the simulation. Moreover, derived output properties can be added after the fact or on an ad-hoc-basis by the end-user. This greatly increases the flexibility of the present invention.

The following is an exemplary derived output data scenario to illustrate how derived output data may be generated. A simulation experiment produces output data for the properties IBM.price, GM.price, and the cumulative inflation rate. IBM.price represents the price of IBM at the close of each business day. GM.price represents the price of General Motors (GM) at the close of each business day. An end-user is interested in the real price of both IBM and General Motors, which is equivalent to the price of IBM divided by the cumulative inflation rate and the price of GM divided by the cumulative inflation rate, respectively.

The present invention provides a mechanism for creating new derived output properties for the real price of both IBM (IBM.realprice) and GM (GM.realprice), where:

IBM.realprice=IBM.price/cumulative inflation rate; and GM.realprice=GM.price/cumulative inflation rate.

As long as the values of IBM.price, GM.price, and cumulative inflation rate have been saved within memory, these new derived output properties may be generated after the execution of the simulation experiment or on an ad-hoc basis by the end-user.

### V. Environment

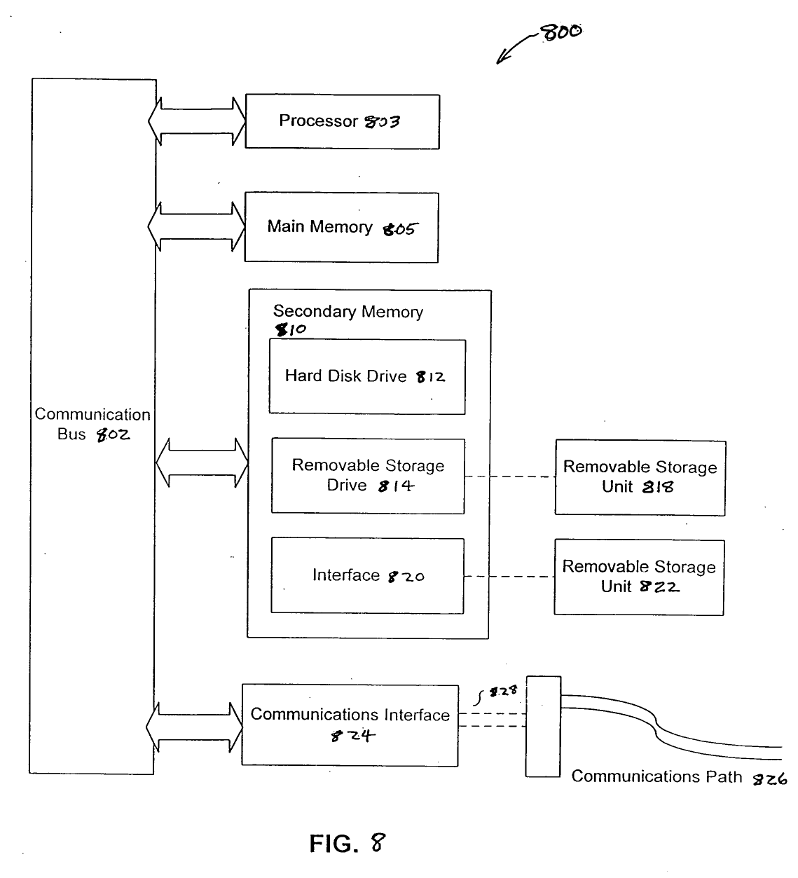

The present invention may be implemented using hardware, software, or a combination thereof and may be implemented in one or more computer systems or other processing systems. In fact, in one embodiment, the invention is directed toward one or more computer systems capable of carrying out the functionality described herein. An example implementation of a computer system 800 is shown in FIG. 8. Various embodiments are described in terms of this exemplary computer system 800. After reading this description, it will be apparent to a person skilled in the relevant art how to implement the invention using other computer systems and/or computer architectures. The computer system 800 includes one or more processors, such as processor 803. The processor 803 is connected to a communication bus 802.

Computer system 800 also includes a main memory 805, preferably random access memory (RAM), and may also include a secondary memory 810. The secondary memory 810 may include, for example, a hard disk drive 812 and/or a removable storage drive 814, representing a floppy disk drive, a magnetic tape drive, an optical disk drive, etc. The removable storage drive 814 reads from and/or writes to a removable storage unit 818 in a well-known manner. Removable storage unit 818, represents a floppy disk, magnetic tape, optical disk, etc., which is read by and written to by removable storage drive 814. As will be appreciated, the removable storage unit 818 includes a computer usable storage medium having stored therein computer software and/or data.

In alternative embodiments, secondary memory 810 may include other similar means for allowing computer programs or other instructions to be loaded into computer system 800. Such means may include, for example, a removable storage unit 822 and an interface 820. Examples of such may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 may also include a communications interface 824. Communications interface 824 allows software and data to be transferred between computer system 800 and external devices. Examples of communications interface 824 may include a modem, a network interface (such as an Ethernet card), a communications port, a PCMCIA slot and card, a wireless LAN (local area network) interface, etc. Software and data transferred via communications interface 824 are in the form of signals 828 which may be electronic, electromagnetic, optical, or other signals capable of being received by communications interface 824. These signals 828 are provided to communications interface 824 via a communications path (i.e., channel) 826. This channel 826 carries signals 828 and may be implemented using wire or cable, fiber optics, a phone line, a cellular phone link, a wireless link, and other communications channels.

In this document, the term “computer program product” refers to removable storage units 818, 822, and signals 828. These computer program products are means for providing software to computer system 800. The invention is directed to such computer program products.

Computer programs (also called computer control logic) are stored in main memory 805, and/or secondary memory 810 and/or in computer program products. Computer programs may also be received via communications interface 824. Such computer programs, when executed, enable the computer system 800 to perform the features of the present invention as discussed herein. In particular, the computer programs, when executed, enable the processor 803 to perform the features of the present invention. Accordingly, such computer programs represent controllers of the computer system 800.

In an embodiment where the invention is implemented using software, the software may be stored in a computer program product and loaded into computer system 800 using removable storage drive 814, hard drive 812 or communications interface 824. The control logic (software), when executed by the processor 803, causes the processor 803 to perform the functions of the invention as described herein.

In another embodiment, the invention is implemented primarily in hardware using, for example, hardware components such as application specific integrated circuits (ASICs). Implementation of hardware state machine(s) so as to perform the functions described herein will be apparent to persons skilled in the relevant art(s).

In yet another embodiment, the invention is implemented using a combination of both hardware and software.

### VI. Conclusion

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

1. A method for configuring a stochastic simulation model, comprising the steps of:
(a) creating an arbitrarily complex functional expression from a library of functional expression components; and
(b) creating an adaptor object;
wherein the adapter object serves as an intermediary between the arbitrarily complex functional expression and a target domain object within the stochastic simulation model so as to modify a property of the target domain object in accordance with the arbitrarily complex functional expression at runtime.

2. A system for a stochastic simulation, comprising:
a plurality of functional expression components wherein at least one of said plurality of functional expression components is selected from the group consisting of:
a stochastic function and an object reference function; and
at least one domain object having a property responsive to said at least one of said plurality of functional expression components at runtime.

3. The method of claim 1, further comprising the step of:
enabling an end-user to define inputs and outputs to the stochastic simulation model using the adapter object.

4. The method of claim 1, further comprising the step of:
enabling an end-user to define derived output expressions, wherein the derived output expressions create outputs derived from a previous simulation output, yet determined separate from the execution of an original stochastic simulation model output.

5. The method of claim 1, wherein the arbitrarily complex functional expressions include one or more stochastic and inter-object relationship functions, wherein the one or more stochastic and inter-object relationship functions only have a value at run-time.

6. The method of claim 1, further comprising the steps of:
determining the order in which each domain entity in the stochastic simulation model is to be evaluated at run-time; and
generating a dependency graph listing the domain entities in the order in which each domain entity must be evaluated during processing of the stochastic simulation model.

7. The method of claim 1, further comprising the steps of:
processing the stochastic simulation model; and
updating each object in the stochastic simulation model for each period in each run of the stochastic simulation model.

8. The method of claim 7, wherein said processing step further comprises the steps of:
(1) initializing the stochastic simulation model for a new run, wherein each object initializes itself to its original starting state;
(2) processing the stochastic simulation model for each period, wherein processing for each period comprises the steps of,
(a) processing the stochastic simulation model for each object in the stochastic simulation model, wherein processing for each object comprises the steps of,
(i) evaluating each arbitrarily complex functional expression for each object in the order in which the arbitrarily complex functional expression falls within the dependency graph; and
(ii) updating the internal state of each object before processing the next period;
(b) repeating steps (a)(i) through (a)(ii) until every object has been evaluated;
(3) repeating step (2) until every period has been evaluated; and
(4) repeating steps (1) through (3) until every run has been evaluated.

9. The method of claim 1, further comprising the steps of:
(1) tracking the values of output properties; and
(2) storing the output property values over each period in which the stochastic simulation model is processed.

10. The method of claim 9, wherein step (2) further comprises the step of storing the output property values as a data structure for displaying and analyzing the data produced during processing of the stochastic simulation model.

11. The method of claim 10, wherein said step of storing the output property values as a data structure comprises the step of storing the output property values using a n-dimensional matrix data structure, wherein the n-dimensional matrix data structure can be manipulated from any perspective to identify a specific value of the n-dimensional matrix.

12. The method of claim 1, further comprising the step of:
enabling an end-user to define a specific subset of periods for processing the stochastic simulation model.

13. A computer program product comprising a computer useable medium including control logic stored therein, said control logic enabling configuration of a stochastic simulation model, said control logic comprising:
creating means for enabling a processor to create an arbitrarily complex functional expression from a library of functional expression components; and
creating means for enabling a processor to create an adaptor object;
wherein the adapter object serves as an intermediary between the arbitrarily complex functional expression and a target domain object within the stochastic simulation model so as to modify a property of the target domain object in accordance with the arbitrarily complex functional expression at runtime.

14. The computer program product of claim 13, said control logic further comprising:
enabling means for enabling a processor to enable an end-user to define inputs and outputs to the stochastic simulation model using the adapter object.

15. The computer program product of claim 13, said control logic further comprising:
enabling means for enabling a processor to enable an end-user to define derived output expressions, wherein the derived output expressions create outputs derived from a previous simulation output, yet determined separate from the execution of an original stochastic simulation model output.

16. The computer program product of claim 13, wherein the arbitrarily complex functional expressions include one or more stochastic and inter-object relationship functions, wherein the one or more stochastic and inter-object relationship functions only have a value at run-time.

17. The computer program product of claim 13, said control logic further comprising:
determining means for enabling a processor to determine the order in which each domain entity in the stochastic simulation model is to be evaluated at run-time; and generating means for enabling a processor to generate a dependency graph listing the domain entities in the order in which each domain entity must be evaluated during processing of the stochastic simulation model.

18. The computer program product of claim 13, said control logic further comprising:
processing means for enabling a processor to process the stochastic simulation model; and
updating means for enabling a processor to update each object in the stochastic simulation model for each period in each run of the stochastic simulation model.

19. The computer program product of claim 18, wherein said processing means further comprises:
initializing means for enabling a processor to initialize the stochastic simulation model for a new run, wherein each object initializes itself to its original starting state; processing means for enabling a processor to process the stochastic simulation model for each period, wherein processing for each period comprises,
processing means for enabling a processor to process the stochastic simulation model for each object in the stochastic simulation model, wherein processing for each object comprises,
evaluating means for enabling a processor to evaluate each arbitrarily complex functional expression for each object in the order in which the arbitrarily complex functional expression falls within the dependency graph; and
updating means for enabling a processor to update the internal state of each object before processing the next period;
repeating means for enabling a processor to repeat said evaluating means and said updating means until every object has been evaluated;
repeating means for enabling a processor to repeat said processing means for enabling a processor to process the stochastic simulation model for each period until every period has been evaluated; and
repeating means for enabling a processor to repeat said processing means for enabling a processor to process the stochastic simulation model for each run until every run has been evaluated.

20. The computer program product of claim 13, said control logic further comprising:
tracking means for enabling a processor to track the values of output properties; and
storing means for enabling a processor to store the output property values over each period in which the stochastic simulation model is processed.

21. The computer program product of claim 20, wherein said storing means further comprises storing means for enabling a processor to store the output property values as a data structure for displaying and analyzing the data produced during processing of the stochastic simulation model.

22. The computer program product of claim 21, wherein said storing means comprises storing means for enabling a processor to store the output property values using a n-dimensional matrix data structure, wherein the n-dimensional matrix data structure can be manipulated from any perspective to identify a specific value of the n-dimensional matrix.

23. The computer program product of claim 13, said control logic further comprising:
enabling means for enabling a processor to enable an end-user to define a specific subset of periods for processing the stochastic simulation model.

24. A stochastic simulation framework/engine, comprising:
an initialization phase for generating a dependency graph comprising functional expressions having inter-object relationships and stochastic functions, wherein said inter-object relationships and stochastic functions only have a value at runtime;
a processing phase for processing a simulation model and updating a plurality of objects in said simulation model for each period in a run, wherein said functional expressions are evaluated for each of said objects in the order in which they appear in said dependency graph; and
an output phase for tracking the value of properties designated as output properties;
wherein an adapter object serves as an intermediary between said functional expressions and said each of said plurality of objects within said simulation model as to modify a property of said objects in accordance with said functional expressions at runtime.

25. The stochastic simulation framework/engine of claim 24, wherein said initialization phase performs random variate initializations to provide object correlation between said objects and variance reduction techniques.

26. The stochastic simulation framework/engine of claim 24, wherein said property of said objects includes one of an input property and an output property.

27. The stochastic simulation framework/engine of claim 26, wherein said input property is also a property to be tracked as said output property.

28. The stochastic simulation framework/engine of claim 24, wherein said functional expressions are arithmetic expressions formed from one or more functional expression components found in a library of functional expressions.

29. The stochastic simulation framework/engine of claim 24, wherein each of said functional expressions is written to said adapter object without knowing which of said input properties will receive said functional expression.

30. The stochastic simulation framework/engine of claim 24, wherein said stochastic simulation framework/engine requests a value from said adapter object and said adapter object retrieves said value for said output properties without the stochastic simulation framework/engine knowing how said value was retrieved or from where said value was retrieved.

31. The stochastic simulation framework/engine of claim 24, wherein derived output expressions are used to create new output data derived from an original simulation output.
